(19) United States
(12) Patent Application Publication
(10) Pub. No.: US 2025/0076082 A1
(43) Pub. Date: Mar. 6, 2025

(54) Angle Sensor Arrangement, and Angle Determination Method

(71) Applicant: Robert Bosch GmbH, Stuttgart (DE)

(72) Inventors: Michael Kleinknecht, Lehrensteinsfeld (DE); Stefan Kuntz, Flein (DE)

(21) Appl. No.: 18/725,697

(22) PCT Filed: Dec. 19, 2022
(86) PCT No.: PCT/EP2022/086532

§ 371 Date: Jun. 28, 2024

(30) Foreign Application Priority Data
Jan. 5, 2022 (DE) 10 2022 200 058.7

(51) Int. Cl. G01D 3/02; G01D 5/244

(52) U.S. Cl. CPC G01D 3/02; G01D 5/2448

(57) ABSTRACT

An angle sensor arrangement includes a measuring transducer, a measurement acquisition device, a signal processing device, a correction device, and an angle calculation device. The measurement acquisition device is configured to acquire at least one physical variable representing a current angular position of the measuring transducer and to output at least two measurement signals which each represent a current angular position of the measuring transducer. The signal processing device is configured to process the at least two measurement signals and to amplify each with a variably adjustable amplification factor and, if necessary, to digitize them and make the processed measurement signals available to the correction device. The correction device is configured to adaptively calculate at least one correction coefficient depending on the amplification factor currently set in the signal processing device and to correct the at least two processed measurement signals accordingly.

The invention relates to an angle sensor arrangement and a corresponding angle determination method. The object of the present invention is also an arrangement for determining an angular difference, as well as a computer program and a device for executing the computer program.

It is known in the prior art to determine an angular position or angular location of a rotor using inductive rotor position sensors by mathematically transforming two measured signals, which are also referred to as measurement signals. For this purpose, a sine channel generally provides a corresponding sine signal of the angular position of the rotor, and a cosine channel provides a corresponding cosine signal of the angular position of the rotor. The current angular position of the rotor can then be calculated from the sine signal and the cosine signal by means of an arctangent function. The raw signals measured are subject to errors due to deviations in the layout of the sine channel and in the cosine channel, in the measurement principle, etc. In particular, the signals are subject to an offset caused by, e.g., metallically conductive surroundings and the conductor tracks on the printed circuit board. These deviations cause an error in the angle measured in comparison with the actual angle of rotation. Suitable correction methods, which can be used to reduce the error by transforming the input signals before the angle is calculated, are known from the prior art.

One method for determining an angular difference on a divided shaft comprising phase tracks and an interposed torsion bar is known from EP 1 315 954 B1, in which ambiguous phase signals are obtained in relation to the rotation of the shaft by means of associated sensors and an evaluation unit. In this case, at least two phase signals are added together in a weighted manner to form a single signal. A non-integer portion, which is proportional to the angular difference, is formed from this signal. The torque acting on the shaft is determined from the angular difference by multiplying the latter by the spring rate of the intermediate torsion bar.

### DISCLOSURE OF THE INVENTION

The angle sensor arrangement having the features of independent claim 1 as well as the angle determination method having the features of independent claim 14 each have the advantage that correction coefficients are adaptively calculated on the basis of a current amplification factor setting. The correction coefficients for correcting the measurement signals are adjusted to the current amplification factor by suitable methods. As a result, it is possible to correct the measured signals in a manner which is adjusted to the current amplification factor and makes it possible to minimize the angle error.

Embodiments of the present invention provide an angle sensor arrangement comprising a measuring transducer, a measurement acquisition device, a signal processing device, a correction device, and an angle calculation device. The measurement acquisition device is designed to acquire at least one physical variable representing a current angular position of the measuring transducer and to output at least two measurement signals, which each represent a current angular position of the measuring transducer. The signal processing device is designed to process the at least two measurement signals and to amplify each by a variably adjustable amplification factor and, if necessary, to digitize them and to make the processed measurement signals available to the correction device. In this case, the correction device is designed to adaptively calculate at least one correction coefficient depending on the current amplification factor set in the signal processing device, to correct the at least two processed measurement signals accordingly, and to output the at least two corrected measurement signals. The angle calculation device is designed to calculate the current angular position of the measuring transducer by means of at least one mathematical transformation of the at least two corrected measurement signals.

Further proposed is an arrangement for determining an angular difference, comprising two such angle sensor arrangements and a calculation unit. In this case, a first such angle sensor arrangement provides a first current angular position of a first measuring transducer, and a second angle sensor arrangement provides a second current angular position of a second measuring transducer. The calculation unit is designed to calculate and output a difference angle from the first current angular position and the second current angular position.

Also proposed is an angle determination method for a measuring transducer using such an angle sensor arrangement. In this case, at least two different measurement signals are provided, which each represent a current angular position of the measuring transducer. The at least two measurement signals are processed by amplifying each of the at least two measurement signals by a variably adjustable amplification factor and digitizing them if necessary. Depending on the current amplification factor setting, at least one correction coefficient is adaptively calculated and the at least two processed measurement signals are corrected accordingly. By means of at least one mathematical transformation of the at least two corrected measurement signals, the current angular position of the measuring transducer is calculated and output.

The measuring transducer can, e.g., be designed as a rotor, the current angular position of which is to be established. Alternatively, the measuring transducer can be designed as a linear displacement transducer, the translational motion of which is likewise to be evaluated by means of a current angular position acquired, whereby a current angular position acquired is proportional to the distance traveled by the linear displacement transducer.

Hereinafter, the measurement acquisition device can be understood to mean a device comprising at least one sensor element for acquiring the physical variable representing the current angular position of the measuring transducer. In this case, the measurement acquisition device can be designed to condition and further process the physical variable acquired by the at least one sensor element so that a plurality of measurement signals can, e.g., be generated and output from the physical variable acquired. In other words, in this embodiment, a number “n” of measurement signals output is based on a number “m” of sensor elements which acquired the physical variables, whereby the number “m” of sensor elements is lower than the number “n” of measurement signals output. Of course, the measurement signals output can also each be generated from a separately acquired physical variable. In other words, in this embodiment, the number “n” of measurement signals output corresponds to the number “n” of sensor elements acquiring the physical variables. The at least two measurement signals output have a specific phase relationship to one another, whereby an unambiguous angle value can be obtained from the ambiguous measurement signals which are shifted in relation to one another. The at least measurement signals output can, e.g., be obtained by using RADAR, laser, optical, magnetic, inductive or other sensor principles.

In the present case, the signal processing device can be understood to mean an electrical or electronic assembly which receives and processes the at least two measurement signals output from the measurement acquisition device. For this purpose, the signal processing device can comprise at least one analog or digital interface for receiving the measurement signals. To process the at least two measurement signals, the signal processing device can comprise at least one analog or digital amplifier and a corresponding automatic amplification control means and, if necessary, at least one analog-to-digital converter. If the signal processing device comprises at least one analog interface and at least one digital amplifier, then the at least one analog-to-digital converter can be arranged between the analog interface and the digital amplifier. If the signal processing device comprises at least one analog interface and at least one analog amplifier, then the analog interface can be connected directly to the analog amplifier and the at least one analog-to-digital converter can alternatively be arranged between the at least one analog amplifier and an output of the signal processing device. If the measurement acquisition device provides the measurement signals in digital form, e.g. via a data bus system, then the signal processing device can comprise at least one digital interface and a digital amplifier. In this embodiment, the at least one analog-to-digital converter is arranged part of the measurement acquisition device.

In the present case, the correction device can be understood to mean an electrical or electronic assembly which receives and corrects the at least two processed measurement signals from the signal processing device. For this purpose, the correction device can have at least one digital interface for receiving the processed measurement signals. To correct the at least two measurement signals, the correction device can comprise at least one calculation block and at least one corresponding correction block.

In the present case, the angle calculation device can be understood to mean an electrical or electronic assembly which receives the at least two corrected measurement signals from the correction device and calculates the current angular position of the measuring transducer. For this purpose, the angle calculation device can have at least one digital interface for receiving the corrected measurement signals. To calculate the current angular position, the angle calculation device can comprise at least one calculation block.

The at least one digital interface and/or the at least one digital amplifier of the signal processing device and/or the at least one digital interface and/or the at least one calculation block and/or the at least one correction block of the correction device and/or the at least one digital interface and/or the at least one calculation block of the angle calculation device can take the form of hardware and/or software. When in hardware form, these digital components of the signal processing device and/or the correction device and/or the angle calculation device can, e.g., form part of what is referred to as a system ASIC which comprises a wide variety of functions of the signal processing device and/or the correction device and/or the angle calculation device. It is also possible, however, that the digital components are separate integrated circuits or consist at least in part of discrete components. When in software form, the digital components can, e.g., be software modules provided on a microcontroller in addition to other software modules. Also advantageous is a computer program product comprising program code which is stored on a machine-readable carrier, e.g. a semiconductor memory, a hard drive memory, or an optical memory, and is used to process the at least two measurement signals and/or to correct the at least two processed measurement signals and/or to calculate the current angular position based on the at least two processed measurement signals, when the program is performed by an appropriate device, e.g. the signal processing device, and/or the correction device, and/or the angle calculation device.

Advantageous improvements to the angle sensor arrangement specified in independent claim 1 and the angle determination method for a measuring transducer specified in independent claim 13 are made possible by the measures and embodiments specified in the dependent claims.

It is particularly advantageous that the correction device can be further designed to perform an offset correction and/or an amplification factor correction and/or a phase correction and/or a harmonic correction of the processed measurement signals using the at least one correction coefficient. In a particularly simple and cost-effective exemplary embodiment of the angle sensor arrangement, the correction device performs only one offset correction of the at least two processed measurement signals. Of course, the correction device can also perform other suitable corrections, which have not been specified, to the at least two processed measurement signals. In addition, the corrections to be performed can be combined as desired. The correction device can, e.g., thus combine the amplification factor correction with the offset correction of the at least two processed measurement signals.

In one advantageous embodiment of the angle sensor arrangement, an “n”-channel measurement acquisition device can provide “n” measurement signals of a current angular position of the measuring transducer, which can be processed by the signal processing device and corrected by the correction device. In this case, the correction device can output “n” corrected measurement signals to a transformation device, which can be designed to transform the “n” corrected measurement signals by means of at least one mathematical transformation into a corrected sine signal and a corrected cosine signal and to output them, whereby the angle calculation device can be designed to calculate the current angular position of the measuring transducer from the corrected sine signal and the corrected cosine signal by means of an arctangent function. In this embodiment, the “n” measurement signals are first processed and corrected and then transformed into two corrected measurement signals. Alternatively, an “n”-channel measurement acquisition device can provide “n” measurement signals of a current angular position of the measuring transducer, which are processed by the signal processing device. In this case, the signal processing device can output “n” processed measurement signals to a transformation device, which can be designed to transform the “n” processed measurement signals by means of at least one mathematical transformation into a processed sine signal and a processed cosine signal and to output them to the correction device, whereby the correction device can be designed to correct the processed sine signal and the processed cosine signal and to output a corrected sine signal and a corrected cosine signal to the angle calculation device, which can be designed to calculate the current angular position of the measuring transducer from the corrected sine value and the corrected cosine value by means of an arctangent function. In this embodiment, the “n” measurement signals are first processed and then transformed into two processed measurement signals, which are then corrected.

In a preferred embodiment of the angle sensor arrangement, a two-channel measurement acquisition device can provide a sine signal as the first measurement signal and a cosine signal as the second measurement signal of a current angular position of the measuring transducer, these signals being processed by the signal processing device. In this case, the signal processing device can output a processed sine signal as the first processed measurement signal and a processed cosine signal as the second processed measurement signal of a current angular position of the measuring transducer to the correction device. The correction device can output a corrected sine signal as the first corrected measurement signal and a corrected cosine signal as the second corrected measurement signal to the angle calculation device, which can be designed to calculate the current angular position of the measuring transducer from the corrected sine value and the corrected cosine value by means of an arctangent function. In the preferred embodiment, only two measurement signals having a specified phase shift of 90° are provided, processed, and corrected.

In a further advantageous embodiment of the angle sensor arrangement, the signal processing device and the correction device can each have a single-channel design. In this case, an n-channel multiplexer can be looped in between the measurement acquisition device and the signal processing device and can provide the “n” measurement signals of a current angular position of the measuring transducer consecutively to the signal processing device, which processes and outputs the “n” measurement signals consecutively. The single-channel correction device can correct and output the “n” processed measurement signals from the single-channel signal processing device consecutively, whereby an n-channel demultiplexer can receive and store the “n” corrected measurement signals consecutively and output them simultaneously to the angle calculation device. In this embodiment, both the signal processing device and the correction device have a single-channel design, so the multiplexer is arranged before the signal processing device and the demultiplexer is arranged after the correction device. Alternatively, the signal processing device can have a single-channel design and the correction device can have a multi-channel design, whereby between the single-channel signal processing device and the multi-channel correction device, an n-channel demultiplexer can be looped in, which can receive and store the “n” processed measurement signals consecutively and output them simultaneously to the multi-channel correction device. In this embodiment, only the signal processing device has a single-channel design, so the multiplexer can be arranged before the signal processing device, and the demultiplexer can be arranged after the signal processing device. In a further alternative embodiment of the angle sensor arrangement, the signal processing device can have a multi-channel design and the correction device can have a single-channel design. In this case, an n-channel multiplexer can be looped in between the multi-channel signal processing device and the single-channel correction device and can provide the “n” adjusted measurement signals of a current angular position of the measuring transducer consecutively to the correction device, which receives, corrects and outputs the “n” processed measurement signals consecutively. In this alternative embodiment, an n-channel demultiplexer can be looped in between the correction device and the angle calculation device and can receive and store the “n” corrected measurement signals consecutively and output them simultaneously to the angle calculation device. The multiplexer and the demultiplexer can also be employed in the two-channel design of the measurement acquisition device to enable single-channel signal processing and/or single-channel correction of the two measurement signals output.

In a further advantageous embodiment of the angle sensor arrangement, the correction device can be further designed to adjust the at least one correction coefficient to the current amplification factor setting via a linear mathematical relationship or a conversion table created and stored in advance. This makes it possible to implement the correction device in a simple and cost-effective manner.

In a further advantageous embodiment of the angle sensor arrangement, the correction device can, e.g., comprise at least one calculation block and at least one correction block for each measurement channel. In this case, the at least one calculation block can be designed to adaptively calculate the at least one correction coefficient for the processed at least two measurement signals depending on the current amplification factor setting and to provide it to the corresponding correction block, which corrects the processed measurement signals accordingly and outputs the corrected measurement signals. In a preferred embodiment, a common calculation block is used for the measurement channels.

In a further advantageous embodiment of the angle sensor arrangement, the signal processing device and/or the correction device and/or the angle calculation device can, e.g., each be designed as an application-specific integrated circuit or as a programmable logic gate arrangement or as a microcontroller.

Exemplary embodiments of the invention are illustrated in the drawings and explained in more detail in the following description. In the drawings, identical reference signs refer to components or elements performing identical or similar functions.

### BRIEF DESCRIPTION OF THE DRAWINGS

FIG. 1 shows a schematic block diagram of a first exemplary embodiment of a measurement acquisition device according to the invention.

FIG. 2 shows a schematic block diagram of a second exemplary embodiment of a measurement acquisition device according to the invention.

FIG. 3 shows a schematic block diagram of a third exemplary embodiment of a measurement acquisition device according to the invention.

FIG. 4 shows a schematic block diagram of a fourth exemplary embodiment of a measurement acquisition device according to the invention.

FIG. 5 shows a schematic block diagram of a sixth exemplary embodiment of a measurement acquisition device according to the invention.

FIG. 6 shows a schematic block diagram of an exemplary embodiment of an arrangement according to the invention for determining an angular difference.

FIG. 7 shows a schematic flow diagram of an exemplary embodiment of a method according to the invention for determining an angle of a measuring transducer using the measurement acquisition device from FIGS. 1 to 5.

### EMBODIMENTS OF THE INVENTION

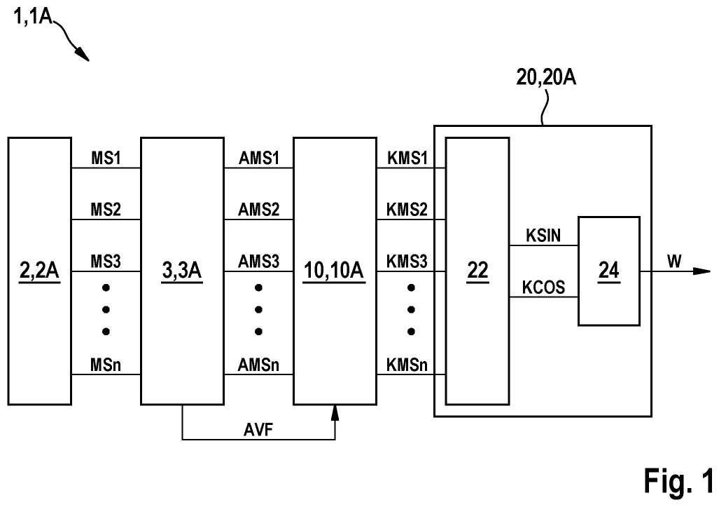

As can be seen from FIGS. 1 to 5, the illustrated exemplary embodiments of an angle sensor arrangement 1, 1A, 1B, 1C, 1D, 1E according to the invention each comprise a measuring transducer (not shown in greater detail), a measurement acquisition device 2, a signal processing device 3, a correction device 10 and an angle calculation device 20, 20A, 20B. The measurement acquisition device 2 acquires at least one physical variable representing a current angular position W of the measuring transducer and outputs at least two measurement signals MS1, MS2, MS3, MSn, which each represent a current angular position W of the measuring transducer. The signal processing device 3 processes the at least two measurement signals MS1, MS2, MS3, MSn and amplifies and each of the at least two measurement signals MS1, MS2, MS3, MSn by a variably adjustable amplification factor. If necessary, the signal processing device 3 digitizes the at least two measurement signals MS1, MS2, MS3, MSn and provides the processed measurement signals AMS1, AMS2, AMS3, AMSn to the correction device 10. In this case, the correction device 10 adaptively calculates at least one correction coefficient KK1, KK2, KK3, KK4 depending on the current amplification factor AVF set in the signal processing device 3 and corrects the at least two processed measurement signals AMS1, AMS2, AMS3, AMSn accordingly and outputs the at least two corrected measurement signals KMS1, KMS2, KMS3, KMSn. The angle calculation device 20, 20A, 20B calculates the current angular position W of the measuring transducer by means of at least one mathematical transformation of the at least two corrected measurement signals KMS1, KMS2, KMS3, KMSn.

As can be further seen from FIGS. 1 to 4, the four illustrated exemplary embodiments of the angle sensor arrangement 1A, 1B, 1C, 1D each comprise an “n”-channel measurement acquisition device 2A, which provides “n” measurement signals MS1, MS2, MS3, MSn of a current angular position W of the measuring transducer. The “n” measurement signals MS1, MS2, MS3, MSn output have a specific phase relationship to one another, whereby an unambiguous angle value W can be obtained from the ambiguous measurement signals MS1, MS2, MS3, MSn, which are shifted in relation to one another. In the exemplary embodiments illustrated, the measurement signals MS1, MS2, MS3, MSn output are obtained using an inductive sensor principle. In exemplary embodiments of the angle sensor arrangement 1 that are not illustrated, other sensor principles, e.g. radar, laser, optical, magnetic or other sensor principles, can be employed to obtain the at least two measurement signals MS1, MS2, MS3, MSn. The “n” measurement signals MS1, MS2, MS3, MSn are processed by the signal processing device 3 and corrected by the correction device 10.

As can further be seen from FIG. 1, the illustrated first exemplary embodiment of the angle sensor arrangement 1A comprises an n-channel signal processing device 3A and an n-channel correction device 10A in addition to the “n”-channel measurement acquisition device 2A. The n-channel signal processing device 3A receives the “n” measurement signals MS1, MS2, MS3, MSn from the “n”-channel measurement acquisition device 2A, processes them, and outputs the “n” processed measurement signals AMS1, AMS2, AMS3, AMSn to the n-channel correction device 10A. The n-channel correction device 10A corrects the “n” processed measurement signals AMS1, AMS2, AMS3, AMSn and outputs the “n” corrected measurement signals KMS1, KMS2, KMS3, KMSn to a transformation device 22. In the illustrated first exemplary embodiment of the angle sensor arrangement 1A, the transformation device 22 is part of the angle calculation device 20A. The transformation device 22 transforms the “n” corrected measurement signals KMS1, KMS2, KMS3, KMSn by means of at least one mathematical transformation into a corrected sine signal KSIN and a corrected cosine signal KCOS and outputs the corrected sine signal KSIN and the corrected cosine signal KCOS to a calculation block 24 of the angle calculation device 20A. In a three-channel design of the correction device 10, the transformation device 22 receives, e.g., three corrected measurement signals KMS1, KMS2, KMS3, each having a phase shift of 120° relative to one another. The transformation device 22 transforms these three corrected measurement signals KMS1, KMS2, KMS3 into the corrected sine signal KSIN and the corrected cosine signal KCOS by means of a Clarke transformation. The corrected sine signal KSIN and the corrected cosine signal KCOS have a phase shift of 90° relative to each other. The calculation block 24 of the angle calculation device 20A calculates the current angular position W of the measuring transducer from the corrected sine signal KSIN and the corrected cosine signal KCOS by means of an arctangent function.

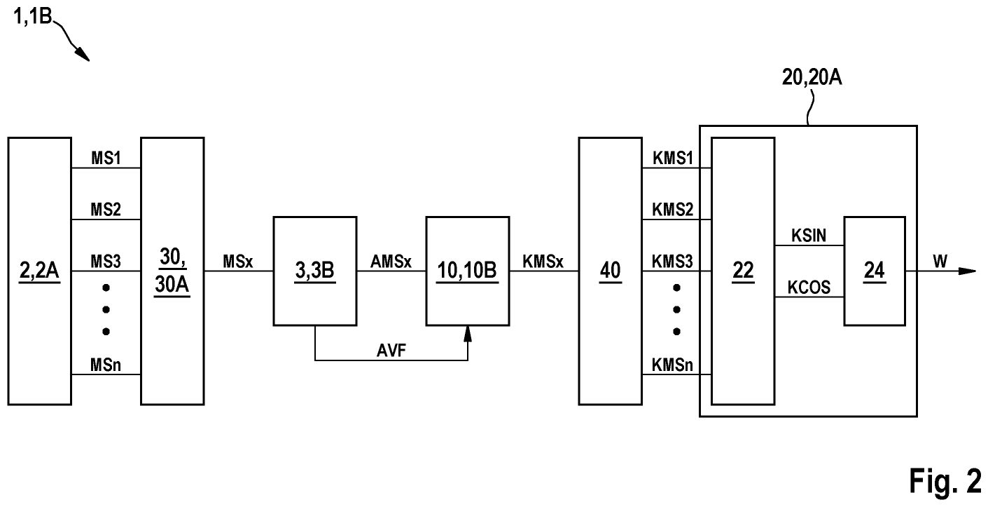

As can further be seen from FIG. 2, the illustrated second exemplary embodiment of the angle sensor arrangement 1B comprises a single-channel signal processing device 3B and a single-channel correction device 10B in addition to the “n”-channel measurement acquisition device 2A. In this case, arranged between the “n”-channel measurement acquisition device 2A and the single-channel signal processing device 3B is an n-channel multiplexer 30 which, in the illustrated exemplary embodiment, is designed as an analog n-channel multiplexer 30A. The n-channel multiplexer 30 receives the “n” measurement signals MS1, MS2, MS3, MSn simultaneously from the “n”-channel measurement acquisition device 2A and provides them consecutively in a specified order as the output signal MSx to the single-channel signal processing device 3B. The single-channel signal processing device 3B processes the “n” measurement signals MS1, MS2, MS3, MSn provided and outputs the “n” processed measurement signals AMS1, AMS2, AMS3, AMSn consecutively as the output signal AMSx to the single-channel correction device 10B. The single-channel correction device 10B corrects the “n” processed measurement signals AMS1, AMS2, AMS3, AMSn and outputs the “n” corrected measurement signals KMS1, KMS2, KMS3, KMSn consecutively as the output signal KMSx to an n-channel demultiplexer 40, which receives and stores the “n” corrected measurement signals KMS1, KMS2, KMS3, KMSn consecutively, and outputs them simultaneously to the transformation device 22. The transformation device 22 is also part of the angle calculation device 20A in the illustrated second exemplary embodiment of the angle sensor arrangement 1B. The transformation device 22 transforms the “n” corrected measurement signals KMS1, KMS2, KMS3, KMSn, in a manner similar to the first exemplary embodiment of the angle sensor arrangement 1A by means of at least one mathematical transformation, into a corrected sine signal KSIN and a corrected cosine signal KCOS, and outputs the corrected sine signal KSIN and the corrected cosine signal KCOS to a calculation block 24 of the angle calculation device 20A. The corrected sine signal KSIN and the corrected cosine signal KCOS have a phase shift of 90° relative to each other. The calculation block 24 of the angle calculation device 20A calculates the current angular position W of the measuring transducer from the corrected sine signal KSIN and the corrected cosine signal KCOS by means of an arctangent function.

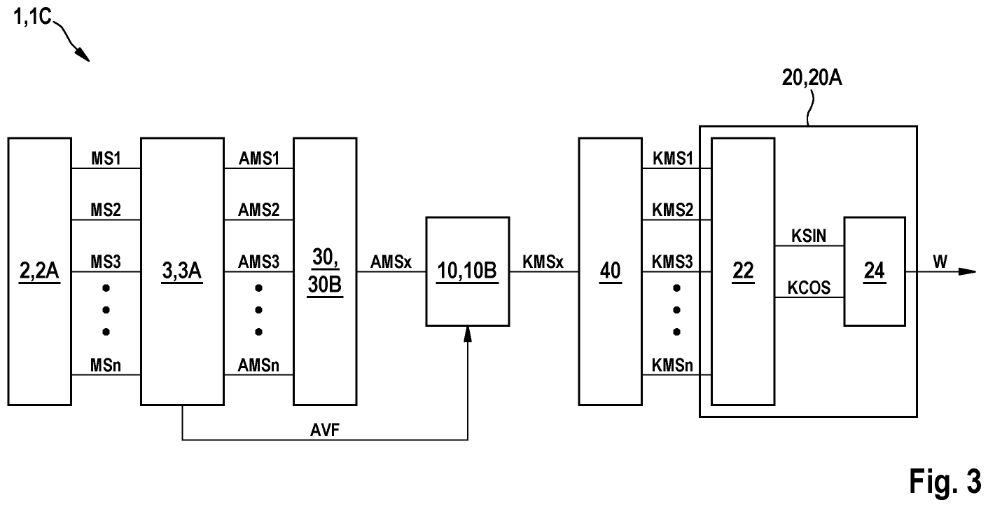

As can be further seen from FIG. 3, the illustrated third exemplary embodiment of the angle sensor arrangement 1C comprises an n-channel signal processing device 3A and a single-channel correction device 10B in addition to the “n”-channel measurement acquisition device 2A. In this case, arranged between the n-channel signal processing device 3A and the single-channel correction device 10B is an n-channel multiplexer 30, which is designed in the illustrated exemplary embodiment as an n-channel digital multiplexer 30A. The n-channel signal processing device 3A receives the “n” measurement signals MS1, MS2, MS3, MSn from the “n”-channel measurement acquisition device 2A, processes them, and outputs the “n” processed measurement signals AMS1, AMS2, AMS3, AMSn to the n-channel multiplexer 30. The n-channel multiplexer 30 receives the “n” processed measurement signals AMS1, AMS2, AMS3, AMSn simultaneously from the “n”-channel signal processing device 3A and provides them consecutively in a specified order as the output signal AMSx to the single-channel correction device 10B. The single-channel correction device 10B corrects the “n” processed measurement signals AMS1, AMS2, AMS3, AMSn and outputs the “n” corrected measurement signals KMS1, KMS2, KMS3, KMSn consecutively as the output signal KMSx to an n-channel demultiplexer 40, which receives and stores the “n” corrected measurement signals KMS1, KMS2, KMS3, KMSn consecutively, and outputs them simultaneously to the transformation device 22. The transformation device 22 is also part of the angle calculation device 20A in the illustrated third exemplary embodiment of the angle sensor arrangement 1B. The transformation device 22 transforms the “n” corrected measurement signals KMS1, KMS2, KMS3, KMSn, analogously to the first and second exemplary embodiments of the angle sensor arrangement 1A, 1B by means of at least one mathematical transformation into a corrected sine signal KSIN and a corrected cosine signal KCOS, and outputs the corrected sine signal KSIN and the corrected cosine signal KCOS to a calculation block 24 of the angle calculation device 20A. The corrected sine signal KSIN and the corrected cosine signal KCOS have a phase shift of 90° relative to each other. The calculation block 24 of the angle calculation device 20A calculates the current angular position W of the measuring transducer from the corrected sine signal KSIN and the corrected cosine signal KCOS by means of an arctangent function.

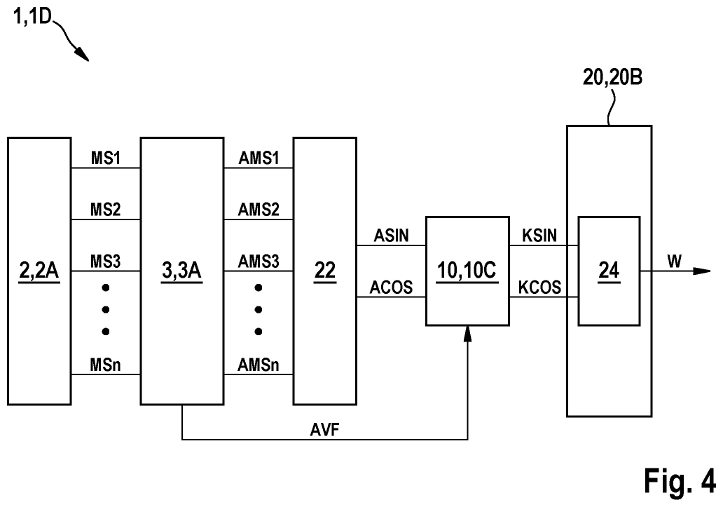

As can further be seen from FIG. 4, the illustrated fourth exemplary embodiment of the angle sensor arrangement 1D comprises an n-channel signal processing device 3A and a two-channel correction device 10C in addition to the “n”-channel measurement acquisition device 2A. In this case, a transformation device 22 is arranged between the n-channel signal processing device 3A and the two-channel correction device 10B. The n-channel signal processing device 3A receives the “n” measurement signals MS1, MS2, MS3, MSn from the “n”-channel measurement acquisition device 2A, processes them, and outputs the “n” processed measurement signals AMS1, AMS2, AMS3, AMSn to the transformation device 22. The transformation device 22 transforms the “n” processed measurement signals AMS1, AMS2, AMS3, AMSn by means of at least one mathematical transformation into a processed sine signal ASIN and a processed cosine signal ACOS and outputs the processed sine signal ASIN and the processed cosine signal ACOS to the two-channel correction device 10C. The two-channel correction device 10C corrects the processed sine signal ASIN and the processed cosine signal ACOS and outputs the corrected sine signal KSIN and the corrected cosine signal KCOS to a calculation block 24 of the angle calculation device 20B. The corrected sine signal KSIN and the corrected cosine signal KCOS have a phase shift of 90° relative to each other. The calculation block 24 of the angle calculation device 20B calculates the current angular position W of the measuring transducer from the corrected sine signal KSIN and the corrected cosine signal KCOS by means of an arctangent function.

In an alternative, non-illustrated exemplary embodiment of the angle sensor arrangement 1, the latter comprises a single-channel signal processing device 3B and an n-channel correction device 10A in addition to the “n”-channel measurement acquisition device 2A. In this case, an n-channel multiplexer 30 is arranged between the “n”-channel measurement acquisition device 2A and the single-channel signal processing device 3B. The n-channel multiplexer 30 receives the “n” measurement signals MS1, MS2, MS3, MSn simultaneously from the “n”-channel measurement acquisition device 2A and provides them consecutively in a specified order as the output signal MSx to the single-channel signal processing device 3B. The single-channel signal processing device 3B processes the “n” measurement signals MS1, MS2, MS3, MSn provided and outputs the “n” processed measurement signals AMS1, AMS2, AMS3, AMSn consecutively as the output signal AMSx to an n-channel demultiplexer 40, which receives and stores the “n” processed measurement signals AMS1, AMS2, AMS3, AMSn consecutively and outputs them simultaneously to the n-channel correction device 10A. The n-channel correction device 10A corrects the “n” processed measurement signals AMS1, AMS2, AMS3, AMSn and outputs the “n” corrected measurement signals KMS1, KMS2, KMS3, KMSn to a transformation device 22. The transformation device 22 transforms the “n” corrected measurement signals KMS1, KMS2, KMS3, KMSn by means of at least one mathematical transformation into a corrected sine signal KSIN and a corrected cosine signal KCOS and outputs the corrected sine signal KSIN and the corrected cosine signal KCOS to a calculation block 24 of the angle calculation device 20A. The corrected sine signal KSIN and the corrected cosine signal KCOS have a phase shift of 90° relative to each other. The calculation block 24 of the angle calculation device 20A calculates the current angular position W of the measuring transducer from the corrected sine signal KSIN and the corrected cosine signal KCOS by means of an arctangent function.

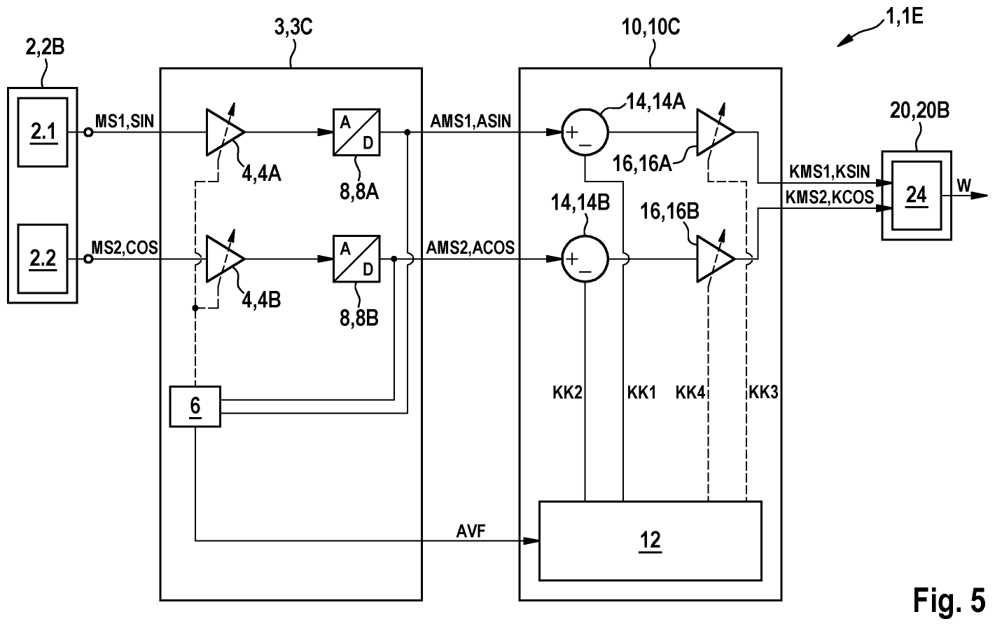

As can be further seen from FIG. 5, the illustrated fifth exemplary embodiment of the angle sensor arrangement 1E comprises a two-channel measurement acquisition device 2B, a two-channel signal processing device 3C, and a two-channel correction device 10C. In the illustrated exemplary embodiment, the two-channel measurement acquisition device 2B comprises two sensor elements 2.1, 2.2. In this case, a first sensor element 2.1 provides a sine signal SIN as the first measurement signal MS1 and a second sensor element 2.2 provides a cosine signal COS as the second measurement signal MS2 of a current angular position W of the measuring transducer, whereby the cosine signal COS is shifted by 90° relative to the sine signal SIN. In contrast, the n-channel measurement acquisition device 2A illustrated in FIGS. 1 to 4 comprises “n” sensor elements (not shown in greater detail), each of which provide one of the measurement signals MS1, MS2, MS3, MSn. The two-channel signal processing device 3C receives the sine signal SIN and the cosine signal COS from the two-channel measurement acquisition device 2B and processes them. As can further be seen from FIG. 5, the two-channel signal processing device 3C in the illustrated exemplary embodiment comprises two analog amplifiers 4, an automatic amplification control means 6, and two analog-to-digital converters 8. In this case, a first analog amplifier 4A and a first analog-to-digital converter 8A form a first channel of the two-channel signal processing device 3C, and a second analog amplifier 4B and a second analog-to-digital converter 8B form a second channel of the two-channel signal processing device 3C. The first analog amplifier 4A amplifies the sine signal SIN and the second analog amplifier 4B amplifies the cosine signal COS. The first analog-to-digital converter 8A converts the amplified analog sine signal SIN into a digital sine signal SIN and outputs the sine signal ASIN processed in this manner to the two-channel correction device 10C. The second analog-to-digital converter 8B converts the amplified analog cosine signal COS into a digital cosine signal COS and outputs the cosine signal ACOS processed in this manner to the two-channel correction device 10C. The automatic amplification control means 6 controls both the amplification in the first channel of the two-channel signal processing device 3C and the amplification in the second channel of the two-channel signal processing device 3C and outputs the current amplification factor AVF settings to the two-channel correction device 10C.

The n-channel signal processing device 3A illustrated in FIGS. 1, 3, and 4 comprises, for each of the “n” channels, an analog amplifier 4 and an analog-to-digital converter 8 and a common automatic amplification control means 6, which controls the amplification in the “n” channels of the n-channel signal processing device 3A. The single-channel signal processing device 3B illustrated in FIG. 2 comprises an analog amplifier 4 and an analog-to-digital converter 8 and an automatic amplification control means 6, which controls the amplification in the channel single-channel signal processing device 3B.

As can be further seen from FIG. 5, the two-channel correction device 10C in the illustrated exemplary embodiment comprises two first correction blocks 14 and two second correction blocks 16 and a calculation block 12 comprise. In this case, the first two correction blocks 14 are each designed as adders 14A, 14B, and the second two correction blocks 16 are each designed as digital amplifiers 16A, 16B. A first adder 14A and a first digital amplifier 16A form a first channel of the two-channel correction device 10C in the illustrated exemplary embodiment. A second adder 14B and a second digital amplifier 16B form a second channel of the two-channel correction device 10C in the illustrated exemplary embodiment. Based on the current amplification factor AVF set for the sine signal SIN, the calculation block 12 adaptively calculates a first correction coefficient KK1 and outputs it to the first adder 14A, which corrects the offset of the processed sine signal ASIN. In addition, based on the current amplification factor AVF set for the cosine signal COS, the calculation block 12 adaptively calculates a second correction coefficient KK2 and outputs it to the second adder 14B, which corrects the offset of the processed cosine signal ACOS. Based on the current amplification factor AVF set for the sine signal SIN, the calculation block 12 adaptively calculates a third correction coefficient KK3, and uses the latter to set the amplification factor of the first digital amplifier 16A in order to correct the amplification factor of the processed sine signal ASIN and to output the corrected sine signal KSIN to the angle calculation device 20B. Furthermore, based on the current amplification factor AVF set for the cosine signal COS, the calculation block 12 adaptively calculates a fourth correction coefficient KK4 and uses the latter to set the amplification factor of the second digital amplifier 16B in order to correct the amplification factor of the processed cosine signal ASOS and to output the corrected cosine signal KCOS to the angle calculation device 20B. The calculation block 12 adjusts the correction coefficients KK1, KK2, KK3, KK4 to the current amplification factor AVF setting via a linear mathematical relationship or a conversion table created and stored in advance. In the illustrated exemplary embodiment, the correction coefficients KK1, KK2 for correcting the offset are calculated via a linear mathematical relationship according to equations (1) and (2).

$$KK 1 = a 1 * AVF 1 + b 1 \qquad ( 1 )$$

$$KK 2 = a 2 * AVF 2 + b 2 \qquad ( 2 )$$

In this case, a1, a2 represent parameters which can, e.g., be established in advance by simulation. The parameters b1, b2 represent, e.g., an offset of the corresponding analog-to-digital converter 8A, 8B. Thus, b1 represents the offset of the first analog-to-digital converter 8A and b2 represents the offset of the second analog-to-digital converter 8B. AVF1 represents the current amplification factor of the first analog amplifier 4A, and AVF2 represents the current amplification factor of the second analog amplifier 4B. The two correction coefficients KK3, KK4 for correcting the amplification factor are adjusted to the current amplification factor AVF setting via a conversion table created and stored in advance.

In the illustrated exemplary embodiment, the angle calculation device 20B comprises a calculation block 24, which calculates the current angular position W of the measuring transducer from the corrected sine value KSIN and the corrected cosine value KCOS by means of an arctangent function.

Of course, the correction device 10 can also perform other, unspecified, suitable corrections, e.g. a phase correction and/or a harmonic correction of the at least two processed measurement signals MS1, MS2, MS3, MSn. In addition, the corrections to be performed can be combined as desired. Furthermore, the correction device 10 can, e.g., also perform solely the amplification factor correction or solely the offset correction of the at least two processed measurement signals AMS1, AMS2, AMS3, AMSn.

The n-channel correction device 10A illustrated in FIG. 1 comprises at least one correction block 14, 16 for each of the “n” channels and a common calculation block 12, which adaptively calculates the correction coefficients KK1, KK2, KK3, KK4 for the at least one correction block 14, 16. The single-channel correction device 10B shown in FIGS. 2 and 3 comprises at least one correction block 14, 16 and a calculation block 12, which adaptively calculates the correction coefficients KK1, KK2, KK3, KK4 for the at least one correction block 14, 16.

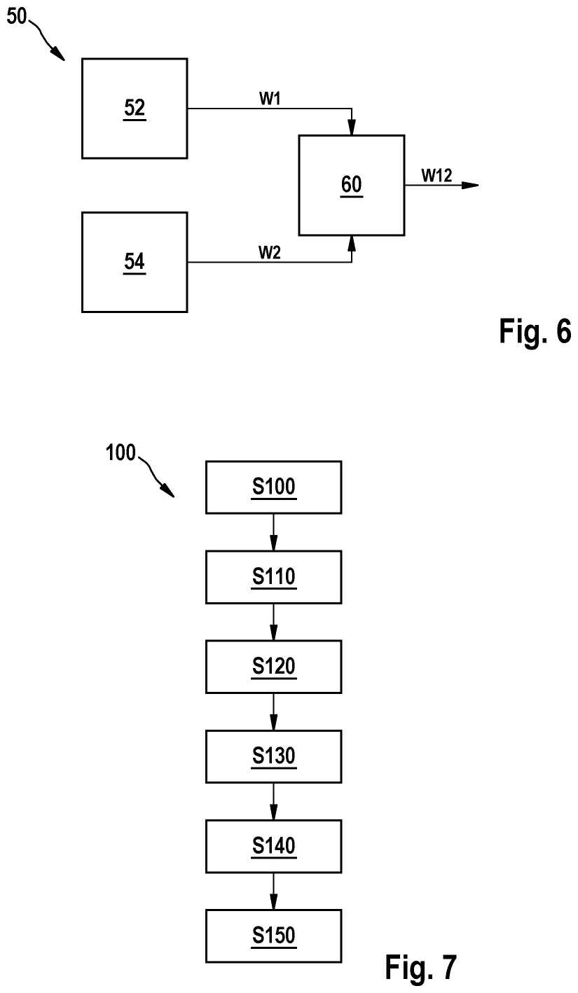

As can be further seen from FIG. 6, the illustrated exemplary embodiment of an arrangement 50 according to the invention for determining an angular difference WD comprises two angle sensor arrangements 52, 54 and a calculation unit 60. The construction and function of the two angle sensor arrangements 52, 54 correspond in each case to the construction and function of one of the angle sensor arrangements 1 described hereinabove. In this case, a first angle sensor arrangement 52 provides a first current angular position W1 of a first measuring transducer, and a second angle sensor arrangement 54 provides a second current angular position W2 of a second measuring transducer. The calculation unit 60 calculates a difference angle from the first current angular position W1 and the second current angular position W2 and outputs this difference angle. The difference angle can, e.g., be used to calculate a torque acting on a shaft.

As can be further seen from FIG. 7, the illustrated exemplary embodiment of a method 100 according to the invention for determining an angle of a measuring transducer using one of the angle sensor arrangements 1 described hereinabove comprises a step S100, in which at least two different measurement signals MS1, MS2, MS3, MSn are provided, which each represent a current angular position W of the measuring transducer. In step S110, the at least two measurement signals MS1, MS2, MS3, MSn are processed by amplifying each of the at least two measurement signals MS1, MS2, MS3, MSn by a variably adjustable amplification factor AVF and digitizing them if necessary. In step S120, at least one correction coefficient KK1, KK2, KK3, KK4 is adaptively calculated depending on the current amplification factor AVF set. In step S130, the at least two processed measurement signals AMS1, AMS2, AMS3, AMSn are corrected accordingly. In step S140, the current angular position W of the measuring transducer is calculated by means of at least one mathematical transformation of the at least two corrected measurement signals KMS1, KMS2, KMS3, KMSn. In step S150, the calculated angular position W of the measuring transducer is output.

As previously explained hereinabove, the at least one correction coefficient KK1, KK2, KK3, KK4 is used to perform an offset correction and/or a amplification factor correction and/or a phase correction and/or a harmonic correction of the at least two processed measurement signals AMS1, AMS2, AMS3, AMSn. The correction coefficients KK1, KK2, KK3, KK4 for an offset correction and/or for a amplification factor correction and/or for a phase correction and/or for a harmonic correction of the processed measurement signals AMS1, AMS2, AMS3, AMSn are each adjusted to the current amplification factor AVF setting via a linear mathematical relationship or a conversion table created and stored in advance.

In an “n”-channel measurement acquisition process, “n” measurement signals MS1, MS2, MS3, MSn are provided in step S100, processed in step S110 and corrected in step S130. In this case, the “n” corrected measurement signals KMS1, KMS2, KMS3, KMSn are transformed in step S140 by at least one mathematical transformation into a corrected sine signal KSIN and a corrected cosine signal KCOS. Subsequently, in step S140, the current angular position W of the measuring transducer is calculated from the corrected sine signal KSIN and the corrected cosine signal TCOS by means of an arctangent function.

In a two-channel measurement acquisition process, in step S100 a sine value SIN is provided as the first measurement signal MS1 and a cosine value COS is provided as the second measurement signal MW2 of a current angular position W of the measuring transducer, these signals being processed in step S110 and corrected in step S130. In step S140, the current angular position W of the measuring transducer is calculated from the corrected sine value KSIN and the corrected cosine value KCOS by means of an arctangent function.

This method 100 can, e.g., be implemented in the form of software or hardware, or in a hybrid form composed of software and hardware, e.g. in a correction device 10.

1. An angle sensor arrangement, comprising:
a measuring transducer;
a measurement acquisition device;
a signal processing device;
a correction device; and
an angle calculation device,
wherein the measurement acquisition device is configured to acquire at least one physical variable representing a current angular position of the measuring transducer, and to output at least two measurement signals which each representing the current angular position of the measuring transducer,
wherein the signal processing device is configured to process the at least two measurement signals and to amplify the at least two measurement signals with a variably adjustable amplification factor and, if necessary, to digitize the at least two measurement signals and to make the at least two processed measurement signals available to the correction device,
wherein the correction device is configured to adaptively calculate at least one correction coefficient depending on a current amplification factor set in the signal processing device and to correct the at least two processed measurement signals accordingly and to output the at least two corrected measurement signals,
wherein the angle calculation device is configured to calculate the current angular position of the measuring transducer based on at least one mathematical transformation of the at least two corrected measurement signals.

2. The angle sensor arrangement according to claim 1, wherein the correction device is further configured to perform an offset correction, an amplification factor correction, a phase correction, and/or a harmonic correction of the at least two processed measurement signals using the at least one correction coefficient.

3. The angle sensor arrangement according to claim 1, wherein:
an “n”-channel measurement acquisition device provides “n” measurement signals of the current angular position of the measuring transducer, which are processed by the signal processing device and corrected by the correction device,
the correction device outputs “n” corrected measurement signals to a transformation device, which is configured to transform the “n” corrected measurement signals based on the at least one mathematical transformation into a corrected sine signal and a corrected cosine signal and to output the corrected sine signal and the corrected cosine signal, and
the angle calculation device is configured to calculate the current angular position of the measuring transducer from the corrected sine signal and the corrected cosine signal based on an arctangent function.

4. The angle sensor arrangement according to claim 1, wherein:
an “n”-channel measurement acquisition device provides “n” measurement signals of a current angular position of the measuring transducer, which are processed by the signal processing device,
the signal processing device outputs “n” processed measurement signals to a transformation device, which is configured to transform the “n” processed measurement signals based on the at least one mathematical transformation into a processed sine signal and a processed cosine signal and to output the processed sine signal and the processed cosine signal to the correction device, and
the correction device is configured to correct the processed sine signal and the processed cosine signal to output a corrected sine signal and a corrected cosine signal to the angle calculation device, which is configured to calculate the current angular position of the measuring transducer from the corrected sine signal and the corrected cosine signal based on an arctangent function.

5. The angle sensor arrangement according to claim 1, wherein:
a two-channel measurement acquisition device provides a sine signal as a first measurement signal and a cosine signal as a second measurement signal of a current angular position of the measuring transducer, which are processed by the signal processing device,
the signal processing device outputs a processed sine signal as the first processed measurement signal and a processed cosine signal as the second processed measurement signal of a current angular position of the measuring transducer to the correction device, and
the correction device outputs a corrected sine signal as the first corrected measurement signal and a corrected cosine signal as the second corrected measurement signal to the angle calculation device, which is configured to calculate the current angular position of the measuring transducer from the corrected sine signal and the corrected cosine signal based on an arctangent function.

6. The angle sensor arrangement according to claim 3, wherein the signal processing device has a single-channel configuration and receives, processes, and outputs the “n” measurement signals of the current angular position of the measuring transducer consecutively.

7. The angle sensor arrangement according to claim 3, wherein the correction device has a single-channel configuration and receives, corrects, and outputs the “n” processed measurement signals consecutively from the single-channel signal processing device or from a multi-channel signal processing device.

8. The angle sensor arrangement according to claim 7, further comprising:
an n-channel multiplexer looped in between a multi-channel measurement acquisition device and the single-channel signal processing device or between the n-channel signal processing device and the single-channel correction device,
wherein the n-channel multiplexer provides the “n” measurement signals of the current angular position of the measuring transducer consecutively to the single-channel signal processing device, which processes and outputs the “n” measurement signals consecutively, or provides the “n” processed measurement signals consecutively to a single-channel correction device, which corrects and outputs the “n” processed measurement signals consecutively.

9. The angle sensor arrangement according to claim 8, further comprising:
an n-channel demultiplexer looped in between the single-channel signal processing device and the multi-channel correction device or between the single-channel correction device and the angle calculation device,
wherein the n-channel demultiplexer receives and stores the “n” processed measurement signals consecutively and outputs them simultaneously to the multi-channel correction device or receives and stores the “n” corrected measurement signals consecutively and outputs them simultaneously to the angle calculation device.

10. The angle sensor arrangement according to claim 1, wherein the correction device is further configured to adjust the at least one correction coefficient to the current amplification factor setting via a linear mathematical relationship or a conversion table created and stored in advance.

11. The angle sensor arrangement according to claim 1, wherein:
the correction device for each measurement channel comprises at least one calculation block and at least one correction block,
the at least one calculation block is configured to adaptively calculate the at least one correction coefficient for the processed at least two measurement signals depending on the current amplification factor set and to make the at least one correction coefficient available to the corresponding correction block, which corrects the processed measurement signals accordingly and outputs the corrected measurement signals.

12. The angle sensor arrangement according to claim 1, wherein the signal processing device, the correction device, and/or the angle calculation device are each configured as an application-specific integrated circuit, a programmable logic gate arrangement, or a microcontroller.

13. An arrangement for determining an angular difference, comprising:
two angle sensor arrangements, each configured according to claim 1;
a calculation unit;
a first angle sensor arrangement configured to provide a first current angular position of a first measuring transducer; and
a second angle sensor arrangement configured to provide a second current angular position of a second measuring transducer,
wherein the calculation unit is to calculate a difference angle from the first current angular position and from the second current angular position and to output the calculated difference angle.

14. A method for determining an angle of a measuring transducer using the angle sensor arrangement according to claim 1, the method comprising:
providing at least two different measurement signals each representing a current angular position of the measuring transducer;
processing the at least two measurement signals by amplifying each of the at least two measurement signals with a variably adjustable amplification factor and digitizing the at least two measurement signals if necessary;
adaptively calculating at least one correction coefficient depending on the amplification factor currently set, and correcting the at least two processed measurement signals accordingly;
calculating the current angular position of the measuring transducer based on at least one mathematical transformation of the at least two corrected measurement signals; and
outputting the calculated current angular position.

15. The method according to claim 14, further comprising:
using the at least one correction coefficient to perform an offset correction, an amplification factor correction, a phase correction, and/or a harmonic correction of the at least two processed measurement signals.

16. The method according to claim 14, wherein:
in an “n”-channel measurement acquisition process, “n” measurement signals are provided, processed, and corrected,
the “n” corrected measurement signals are transformed into a corrected sine signal and a corrected cosine signal by at least one mathematical transformation, and
the current angular position of the measuring transducer is calculated from the corrected sine signal and the corrected cosine signal based on an arctangent function.

17. The method according to claim 14, wherein:
in a two-channel measurement acquisition process, a sine value as the first measurement signal, and a cosine value as the second measurement signal, of a current angular position of the measuring transducer are provided, processed, and corrected, and
the current angular position of the measuring transducer is calculated from the corrected sine value and the corrected cosine value based on an arctangent function.

18. The method according to claim 14, wherein the correction coefficients for an offset correction, for an amplification factor correction, for a phase correction, and/or for a harmonic correction of the processed measurement signals, are each adjusted to the current amplification factor setting via a linear mathematical relationship or a conversion table created and stored in advance.

19. The method according to claim 14, wherein a computer program is configured to perform the method.

20. A device configured to execute the computer program according to claim 19.
